(19) United States
(12) Patent Application Publication
(10) Pub. No.: US 2019/0143635 A1
(43) Pub. Date: May 16, 2019

(54) COMPOSITE CUSHIONING STRUCTURES, AND METHODS OF MANUFACTURING THEREOF

(71) Applicant: Dow Global Technologies LLC, Midland, MI (US)

(72) Inventors: Kaoru Aou, Lake Jackson, TX (US); Ronald Wevers, Tarragona (ES); Viraj K. Shah, Pearland, TX (US)

(21) Appl. No.: 16/308,109

(22) PCT Filed: Jul. 12, 2017
(86) PCT No.: PCT/US2017/041649

§ 371 Date: Dec. 7, 2018

Related U.S. Application Data
(60) Provisional application No. 62/364,904, filed on Jul. 21, 2016.

(51) Int. Cl. B32B 5/24; B32B 5/02; B32B 37/18; B32B 5/18; A47C 27/00; A47C 7/02; A47G 9/10; B60N 2/64

(52) U.S. Cl. CPC B32B 5/245; B32B 2323/046; B32B 37/182; B32B 5/18; B32B 2479/00; B32B 2601/00; B32B 2307/51; B32B 2266/0278; A47C 27/00; B32B 2375/00; A47C 7/02; B32B 2307/56; B32B 2307/724; B32B 2307/732; B32B 2305/022; A47G 9/10; B60N 2/64; B32B 2471/04; B32B 2305/20; B32B 2262/0253; B32B 5/022

(57) ABSTRACT

A composite cushioning structure comprising: a three dimensional random loop layer comprising a plurality of random loops arranged in a three dimensional orientation formed from a polyolefin polymer; and a viscoelastic polyurethane foam layer having an air flow of at least 6.0 ft³/min as measured according to ASTM D3574, Test G and a resiliency of less than or equal to 20%, as measured according to ASTM D3574 Test H.

### TECHNICAL FIELD

Embodiments of the present disclosure generally relate to composite cushioning structures, and specifically relate to composite cushioning structures comprising viscoelastic polyurethane foam and three-dimensional oriented random loop structures.

### BACKGROUND

Cushioning materials are often used to manufacture various articles, such as, bed mattresses, seat cushions, back rest cushions, pillows, upholstered furniture, or any other article where support and/or cushioning is desired. Current cushioning material offerings may be used to bear and distribute the weight of a user, thereby providing the desired support and comfort while balancing durability for a particular application. Despite the durability and cushioning, current cushioning materials can suffer from certain drawbacks. For instance, excess water and moisture may be retained leaving the cushioning material susceptible to breeding bacteria. Additionally, current cushioning materials may absorb heat and lack suitable breathability, thus making the surface of the material in contact with a user warm. During the hotter months, the warm surface of the cushioning material can become uncomfortable to a user. Lastly, current cushioning material offerings may not be easy to reuse or recycle, and are generally discarded (e.g., incinerated or buried), which are undesirable options from an environmental and cost standpoint.

Accordingly, alternative cushioning structures that provide suitable durability and cushioning function, while also providing breathability and/or recyclability, may be desirable.

### SUMMARY

Disclosed in embodiments herein are composite cushioning structures. The composite cushioning structures comprise: a three dimensional random loop layer comprising a plurality of random loops arranged in a three dimensional orientation formed from a polyolefin polymer; and a viscoelastic polyurethane foam layer having an air flow of at least 6.0 ft³/min as measured according to ASTM D3574, Test G and a resiliency of less than or equal to 20%, as measured according to ASTM D3574 Test H.

Also disclosed herein are methods for manufacturing composite cushioning structures. The methods comprise: providing a three dimensional random loop layer comprising a plurality of random loops arranged in a three dimensional orientation formed from a polyolefin polymer; providing a viscoelastic polyurethane foam layer having an air flow of at least 6.0 ft³/min as measured according to ASTM D3574, Test G and a resiliency of less than or equal to 20%, as measured according to ASTM D3574 Test H; and positioning the three dimensional random loop layer and the viscoelastic polyurethane foam layer such that the layers are in a stacked configuration.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 graphically depicts the air flow under compressive strain for several composite cushioning structures using conventional polyurethane foam.

FIG. 2 graphically depicts the air flow under compressive strain for several composite cushioning structures using high airflow polyurethane foam.

### DETAILED DESCRIPTION

Reference will now be made in detail to embodiments of composite cushioning structures, and methods of manufacturing composite cushioning structures, characteristics of which are illustrated in the accompanying drawings. The composite cushioning structures may be used in mattresses, cushions, pillows, upholstered furniture, or any other article where support and/or cushioning is desired. It is noted, however, that this is merely an illustrative implementation of the embodiments disclosed herein. The embodiments may be applicable to other technologies that are susceptible to similar problems as those discussed above. For example, the composite cushioning structures described herein may be used in cushioned mats, cushioned floor pads, footwear inserts, etc., all of which are within the purview of the present embodiments.

### Composite Cushioning Structures

The composite cushioning structures a three dimensional random loop layer and a viscoelastic polyurethane foam layer. The viscoelastic polyurethane foam layer and the three dimensional random loop layer are positioned in a stacked configuration. In some embodiments, the viscoelastic polyurethane foam layer is positioned above the three dimensional random loop layer. In other embodiments, the viscoelastic polyurethane foam layer is positioned below the three dimensional random loop layer. In either configuration, an intermediate layer may be positioned between the three dimensional random loop layer and the viscoelastic polyurethane foam layer.

The composite cushioning structure may be manufactured by providing a three dimensional random loop layer comprising a plurality of random loops arranged in a three dimensional orientation formed from a polyolefin polymer; providing a viscoelastic polyurethane foam layer having an air flow of at least 6.0 ft3/min as measured according to ASTM D3574, Test G; and positioning the three dimensional random loop layer and the viscoelastic polyurethane foam layer such that the layers are in a stacked configuration. In some embodiments, the viscoelastic polyurethane foam layer is positioned above the three dimensional random loop layer. The method may further comprise providing an intermediate layer, and positioning the intermediate layer between the three dimensional random loop layer and the viscoelastic polyurethane foam layer. In some embodiments, the viscoelastic polyurethane foam layer is positioned above the intermediate layer, and the intermediate layer is positioned above the three dimensional random loop layer.

### Three Dimensional Random Loop Layer

The three dimensional random loop layer comprises a plurality of random loops arranged in a three dimensional orientation formed from a polyolefin polymer. As used herein, “polymer” means a polymeric compound prepared by polymerizing monomers, whether of the same or a different type. The generic term “polymer” embraces the terms “homopolymer,” “copolymer,” “terpolymer” as well as “interpolymer.” The polyolefin polymer comprises at least 50 wt. % of the total polymers present in the three dimensional random loop layer. All individual values and subranges are included and disclosed herein.

For example, in some embodiments, the polyolefin polymer comprises at least 75, 85, 95, 99, 99.5 or 100 wt. % of the total polymers present in the three dimensional random loop layer.

In some embodiments herein, the polyolefin polymer is an ethylene/alpha-olefin polymer. Ethylene/α-olefin polymer generally refers to polymers comprising ethylene and an α-olefin having 3 or more carbon atoms. In embodiments herein, the ethylene/α-olefin polymer comprises greater than 50 wt. % of the units derived from ethylene and less than 30 wt. % of the units derived from one or more alpha-olefin comonomers (based on the total amount of polymerizable monomers). All individual values and subranges of greater than 50 wt. % of the units derived from ethylene and less than 30 wt. % of the units derived from one or more alpha-olefin comonomers are included and disclosed herein. For example, the ethylene/α-olefin polymer may comprise (a) greater than or equal to 55%, for example, greater than or equal to 60%, greater than or equal to 65%, greater than or equal to 70%, greater than or equal to 75%, greater than or equal to 80%, greater than or equal to 85%, greater than or equal to 90%, greater than or equal to 92%, greater than or equal to 95%, greater than or equal to 97%, greater than or equal to 98%, greater than or equal to 99%, greater than or equal to 99.5%, from greater than 50% to 99%, from greater than 50% to 97%, from greater than 50% to 94%, from greater than 50% to 90%, from 70% to 99.5%, from 70% to 99%, from 70% to 97% from 70% to 94%, from 80% to 99.5%, from 80% to 99%, from 80% to 97%, from 80% to 94%, from 80% to 90%, from 85% to 99.5%, from 85% to 99%, from 85% to 97%, from 88% to 99.9%, 88% to 99.7%, from 88% to 99.5%, from 88% to 99%, from 88% to 98%, from 88% to 97%, from 88% to 95%, from 88% to 94%, from 90% to 99.9%, from 90% to 99.5% from 90% to 99%, from 90% to 97%, from 90% to 95%, from 93% to 99.9%, from 93% to 99.5% from 93% to 99%, or from 93% to 97%, by weight, of the units derived from ethylene; and (b) less than 30 percent, for example, less than 25 percent, or less than 20 percent, less than 18%, less than 15%, less than 12%, less than 10%, less than 8%, less than 5%, less than 4%, less than 3%, less than 2%, less than 1%, from 0.1 to 20%, from 0.1 to 15%, 0.1 to 12%, 0.1 to 10%, 0.1 to 8%, 0.1 to 5%, 0.1 to 3%, 0.1 to 2%, 0.5 to 12%, 0.5 to 10%, 0.5 to 8%, 0.5 to 5%, 0.5 to 3%, 0.5 to 2.5%, 1 to 10%, 1 to 8%, 1 to 5%, 1 to 3%, 2 to 10%, 2 to 8%, 2 to 5%, 3.5 to 12%, 3.5 to 10%, 3.5 to 8%, 3.5% to 7%, or 4 to 12%, 4 to 10%, 4 to 8%, or 4 to 7%, by weight, of units derived from one or more α-olefin comonomers. The comonomer content may be measured using any suitable technique, such as techniques based on nuclear magnetic resonance (“NMR”) spectroscopy, and, for example, by 13C NMR analysis as described in U.S. Pat. No. 7,498,282, which is incorporated herein by reference.

Suitable alpha-olefin comonomers typically have no more than 20 carbon atoms. The one or more alpha-olefins may be selected from the group consisting of C3-C20 acetylenically unsaturated monomers and C4-C18 diolefins. For example, the alpha-olefin comonomers may have 3 to 10 carbon atoms, or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of propylene, 1-butene, 1-hexene, and 1-octene; or in the alternative, from the group consisting of 1-butene, 1-hexene and 1-octene, or in the alternative, from the group consisting of 1-hexene and 1-octene. In some embodiments, the ethylene/α-olefin polymer comprises greater than 0 wt. % and less than 30 wt. % of units derived from one or more of 1-octene, 1-hexene, or 1-butene comonomers.

Any conventional ethylene (co)polymerization reaction processes may be employed to produce the ethylene/α-olefin polymer composition. Such conventional ethylene (co)polymerization reaction processes include, but are not limited to, gas phase polymerization process, slurry phase polymerization process, solution phase polymerization process, and combinations thereof using one or more conventional reactors, e.g. fluidized bed gas phase reactors, loop reactors, stirred tank reactors, batch reactors in parallel, series, and/or any combinations thereof. Additional ethylene (co)polymerization reaction processes may be found in U.S. Pat. Nos. 5,272,236, 5,278,272, 6,812,289, WO 93/08221, U.S. Pat. Nos. 8,450,438, 4,076,698 and 5,844,045, 7,608,668, and 8,609,794, all of which are incorporated herein by reference.

In embodiments herein, the ethylene/alpha-olefin polymer has a density ranging from 0.870 g/cc to 0.935 g/cc and a melt index (I₂) ranging from 1 to 25 g/10 min. In some embodiments, the ethylene/alpha-olefin polymer may have a density ranging from 0.870 g/cc to 0.890 g/cc or 0.895 g/cc to 0.915 g/cc, and a melt index (I₂) ranging from 1 to 25 g/10 min. The melt index (I₂) may further range from 1 to 20, 3 to 15, or 5 to 15 g/10 minutes.

In addition to density and melt index, the ethylene/α-olefin polymer may further be characterized by a difference between the highest DSC temperature melting peak, Tm, and highest DSC temperature crystallization peak, Tc, of greater than 19.0° C. For example, in some embodiments, the ethylene/α-olefin polymer may have a difference between the highest DSC temperature melting peak, Tm, and highest DSC temperature crystallization peak, Tc, of from 20.0° C. to 30.0° C., 20.0° C. to 28.0° C., 20.0° C. to 25.0° C., 20.0° C. to 24.0° C., or 20.0° C. to 23.0° C. In other embodiments, the ethylene/α-olefin polymer may have a difference between the highest DSC temperature melting peak, Tm, and highest DSC temperature crystallization peak, Tc, of from 19.0° C. to 30.0° C., 19.0° C. to 28.0° C., 19.0° C. to 27.5° C., 19.0° C. to 25.0° C., 19.0° C. to 24.0° C., or 19.0° C. to 23.0° C.

In addition to density, melt index, and Tm−Tc differential, the ethylene/α-olefin polymer may further be characterized by a molecular weight distribution (Mw/Mn) in the range of from 2.0 to 4.5, where Mw is the weight average molecular weight and Mn is the number average molecular weight. All individual values and subranges of 2.0 to 4.5 are included and disclosed herein. For example, the ethylene/α-olefin interpolymer composition may have a molecular weight distribution (Mw/Mn) that can be from 2.0 to 4.0, 2.0 to 3.5, or 2.0 to 3.0. The Mw and Mn may be determined by gel permeation chromatography.

In other embodiments herein, the polyolefin polymer is a propylene interpolymer. Propylene interpolymer generally refers to polymers comprising propylene and an α-olefin having 2 carbon atoms or 4 or more carbon atoms. “Interpolymer” refers to a polymer prepared by the polymerization of at least two different types of monomers. The generic term “interpolymer” includes the term “copolymer” (which is usually employed to refer to a polymer prepared from two different monomers) as well as the term “terpolymer” (which is usually employed to refer to a polymer prepared from three different types of monomers). It also encompasses polymers made by polymerizing four or more types of monomers.

The propylene interpolymer comprises at least 60 wt. % units derived from propylene and between 1 and 40 wt. % units derived from ethylene, wherein the propylene interpolymer has a density of from 0.840 g/cm³ to 0.900 g/cm³, a highest DSC melting peak temperature of from 50.0° C. to 120.0° C., and a melt flow rate of from 1 to 100 g/10 min.

In embodiments herein, the propylene interpolymer comprises at least 60 wt. % of the units derived from propylene and between 1 and 40 wt. % of the units derived from ethylene (based on the total amount of polymerizable monomers). All individual values and subranges of at least 60 wt. % of the units derived from propylene between 1 and 40 wt. % of the units derived from ethylene are included and disclosed herein. For example, in some embodiments, the propylene interpolymer comprises (a) at least 65 wt. %, at least 70 wt. %, at least 75 wt. %, at least 80 wt. %, at least 82 wt. %, at least 85 wt. %, at least 87 wt. %, at least 90 wt. %, at least 92 wt. %, at least 95 wt. %, at least 97 wt. %, from 60 to 99 wt. %, from 60 to 99 wt. %, from 65 to 99 wt. %, from 70 to 99 wt. %, from 75 to 99 wt. %, from 80 to 99 wt. %, from 82 to 99 wt. %, from 84 to 99 wt. %, from 85 to 99 wt. %, from 88 to 99 wt. %, from 80 to 97 wt. %, from 82 to 97 wt. %, from 85 to 97 wt. %, from 88 to 97 wt. %, from 80 to 95.5 wt. %, from 82 to 95.5 wt. %, from 84 to 95.5 wt. %, 85 to 95.5 wt. %, or from 88 to 95.5 wt. %, of the units derived from propylene; and (b) between 1 and 40 wt. %, for example, from 1 to 35%, from 1 and 30%, from 1 and 25%, from 1 to 20%, from 1 to 18%, from 1 to 16%, 1 to 15%, 1 to 12%, 3 to 20%, 3 to 18%, 3 to 16%, 3 to 15%, 3 to 12%, 4.5 to 20%, 4.5 to 18%, 4.5 to 16%, 4.5 to 15%, or 4.5 to 12%, by weight, of units derived from ethylene. The comonomer content may be measured using any suitable technique, such as techniques based on nuclear magnetic resonance (“NMR”) spectroscopy, and, for example, by 13C NMR analysis as described in U.S. Pat. No. 7,498,282, which is incorporated herein by reference.

In embodiments herein, the propylene interpolymers have a density of from 0.840 g/cm³ to 0.900 g/cm³, as measured by ASTM D-792. All individual values and subranges of from 0.840 g/cm³ to 0.900 g/cm³ are included and disclosed herein. For example, in some embodiments the propylene interpolymer has a density of from 0.850 g/cm³ to 0.890 g/cm³, from 0.855 g/cm³ to 0.890 g/cm³, or from 0.860 g/cm³ to 0.890 g/cm³.

In embodiments herein, the propylene interpolymers have a differential scanning calorimetry (“DSC”) melting peak temperature of from 50.0° C. to 120.0° C. All individual values and subranges of from 50.0° C. to 120.0° C. are included and disclosed herein. For example, in some embodiments the propylene interpolymer has a highest DSC melting peak temperature of from 50.0° C. to 115.0° C., from 50.0° C. to 110.0° C., from 50.0° C. to 100.0° C., from 50.0° C. to 90.0° C., from 50.0° C. to 85.0° C., from 70.0° C. to 120.0° C., from 70.0° C. to 110.0° C., from 70.0° C. to 100.0° C.

In embodiments herein, the propylene interpolymers have a melt flow rate of from 1 to 100 g/10 min, as measured according to ASTM D-1238 (2.16 kg, 230° C.). All individual values and subranges of 1 to 100 g/10 min are included and disclosed herein. For example, in some embodiments, the propylene interpolymers have a melt flow rate of from 2 to 50 g/10 min, or from 6 to 30 g/10 min.

In addition to the density, highest DSC melting peak temperature, and melt flow rate, the propylene interpolymers may further have a molecular weight distribution of less than 4. Molecular weight distribution is the ratio of the weight average molecular weight to the number average molecular weight (Mw/Mn). The molecular weights may be determined by gel permeation chromatography. All individual values and subranges of less than 4 are included and disclosed herein. For example, in some embodiments, the propylene interpolymers have a molecular weight distribution of from 2 to 4, 2 to 3.7, 2 to 3.5, 2 to 3.2, 2 to 3, or 2 to 2.8.

In addition to the density, highest DSC melting peak temperature, melt flow rate, and molecular weight distribution, the propylene interpolymers may have a temperature differential between the highest DSC melting peak temperature (Tm) and the DSC crystallization peak temperature (Tc), Tm−Tc, of 25° C.-50° C. All individual values and subranges of 25° C.-50° C. are included and disclosed herein. For example, in some embodiments, the propylene interpolymers may have a temperature differential of Tm−Tc of 30° C.-50° C., or 35° C.-50° C.

In addition to the density, highest DSC melting peak temperature, melt flow rate, molecular weight distribution, and Tm−Tc differential, the propylene interpolymers may have a percent crystallinity, as determined by DSC, in the range of from 0.5% to 45%. All individual values and subranges of from 0.5% to 45% are included and disclosed herein. For example, in some embodiments, the propylene interpolymers may have a percent crystallinity, as determined by DSC, in the range of from 2%-42%.

In further embodiments herein, the cushioning network structures comprise a plurality of random loops arranged in a three-dimensional orientation, wherein the plurality of random loops are formed from a propylene interpolymer comprising at least 60 wt. % units derived from propylene and between 1 and 20 wt. % units (or, in the alternative, 3-18 wt. % units) derived from ethylene, wherein the propylene interpolymer has a density of from 0.860 g/cm³ to 0.900 g/cm³ (or, in the alternative, 0.855 to 0.890 g/cm³), a highest DSC melting peak temperature of from 50° C. to 100.0° C. (or, in the alternative, 50° C. to 90° C.); a melt flow rate of from 2 to 50 g/10 min (or, in the alternative, 6 to 30), and a molecular weight distribution of less than 4.

The propylene interpolymers can be made by any process, and include random, block and graft copolymers. In some embodiments, the propylene interpolymers are of a random configuration. These include interpolymers made by Ziegler-Natta, CGC (Constrained Geometry Catalyst), metallocene, and non-metallocene, metal-centered, heteroaryl ligand catalysis. Additional propylene interpolymerization reaction processes may be found in WO/2007/136493, which are incorporated herein by reference.

The polyolefin polymer may further comprise additional components such as one or more other polymers and/or one or more additives. Such additives include, but are not limited to, antistatic agents, color enhancers, dyes, lubricants, fillers such as TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. The ethylene-based polymer composition may contain from about 0.1 to about 10 percent by the combined weight of such additives, based on the weight of the ethylene-based polymer composition including such additives.

The plurality of random loops in the three dimensional random loop layer may be formed by allowing continuous filaments to bend and come in contact with one another in a molten state, thereby being heat-bonded at random contact points. Thus, in some embodiments, the plurality of random loops is at least partially bonded with one another. Further examples of suitable methods for forming the three dimensional random loop layer are described in U.S. Pat. Nos. 5,639,543, 6,378,150, 7,622,179, and 7,625,629, which are incorporated herein by reference.

In an exemplary method for manufacturing the three dimensional random loop layer, molten polyolefin polymer is delivered to a water cooling unit. Upon cooling, the molten polyolefin polymer forms into a plurality of three dimensional random loops. Thus, the water cooling of the molten polyolefin polymer facilitates formation of three-dimensional random loops which at least partially bond to form the three dimensional random loop layer. The polyolefin polymer is delivered to the water cooling unit via a drive mechanism that is at least partially submerged (of course, it may be fully submerged), in the water cooling unit. The drive mechanism may generally comprise at least one belt, a plurality of rollers, at least one conveyor, or combinations thereof. The drive mechanism may be an underwater mechanism which constrains a thickness of the three dimensional random loop layer. Considering the significant number of filaments being delivered to the water cooling unit, there may be significant bonding of the filaments during looping thereby creating three dimensional random loop layer.

The polyolefin polymer may be in pelletized form and heated and melted in an extruder. The extruder may generally include a hopper, screw and barrel, motor to turn the screw and heaters to heat the barrel. Of course, other configurations for extruder may be used as is known in the art. The polyolefin polymer pellets enter the hopper and are melted in the heated barrel due to heat and shear. As the flight clearance between the screw and barrel reduce going from the hopper to the die end, the solid pellets get softer and melt from the feed zone to the transition zone and finally, at the end near the die, the metering of the melt happens, like a pump, thus generating positive extrusion pressure as the melt exits the die.

The molten polyolefin polymer exiting the die, which is now under positive pressure, may be transferred through a heated transfer pipe into the die. The die may consist of several rows of holes in series. The melt, which enters the die from a round transfer pipe, is uniformly distributed so it can exit the die from each of the individual holes uniformly. The die may be in a horizontal arrangement such that the melt exiting the die, which is now in the form of filaments, travels downward vertically before breaking the surface of the water in the water tank. The air gap or the distance between the die surface and the surface of water is adjustable.

Upon leaving the water cooling unit, the three-dimensional random loops should be sufficiently bonded together to form the three dimensional random loop layer. Excess water may be removed by various mechanisms. Moreover, there is a mechanism to cut the continuously forming structure into a desired length. The network structure provided herein can be a laminate or a composite of various three dimensional random loop layers having different sizes, different deniers, different compositions, different densities, and so on as appropriately selected so as to meet the desired property.

The loop size of the plurality of random loops may vary based on industrial application, and specifically may be dictated by the diameter of the holes in the die. The loop size of the plurality of random loops may also be dictated by the polymer, melt temperature of the filaments coming out of the die, the distance between the die and water, the speed of the belts or rollers or other mechanism under water etc. In some embodiments, each of the plurality of random loops have a diameter of about 0.1 mm to about 3 mm, or a diameter of about 0.6 mm to about 1.6 mm. The apparent density of the layer of plurality of random loops may range from about 0.016 to about 0.1 g/cm³, or about 0.024 to about 0.1 g/cm³ and can be achieved by adjusting various factors.

### Viscoelastic Polyurethane Foam Layer

In embodiments herein, the viscoelastic polyurethane foam layer has an air flow of at least 6.0 ft³/min or, alternatively, at least 7.0 ft³/min as measured according to ASTM D3574, Test G. In addition to the air flow, the viscoelastic polyurethane foam may be further characterized as having a resiliency that is less than or equal to 20% as measured according to ASTM D3574, Test H (may also be referred to as a Ball Rebound Test). For example, the resiliency may be less than 15%, less than 10%, less than 8%, and/or less than 7 wt %. The resiliency may be greater than 1%. In addition to the air flow and resiliency, the viscoelastic polyurethane foam may be further characterized as having a 90% compression set of less than or equal to 8%, less than or equal to 5%, or less than or equal to 4%, as measured according to ASTM D3574, Test D. In all examples, the preferred Cₜ method from ASTM D3574 Test D is used.

The viscoelastic polyurethane foam is the reaction product of (a) an isocyanate component that includes at least one isocyanate having an isocyanate index of the reaction system being from 50 to 110; and (b) an isocyanate-reactive component that is a mixture comprising: from 50.0 wt % to 99.8 wt % (e.g., 60.0 wt % to 99.8 wt %, 70.0 wt % to 99.5 wt %, 80.0 wt % to 99.0 wt %, 90.0 wt % to 99.0 wt %, etc., so as to be the majority component in the reaction system for forming the viscoelastic polyurethane foam) of a polyol component, based on the total weight of the mixture, the polyol component including at least one polyether polyol, from 0.1 wt % to 50.0 wt % of an additive component, based on the total weight of the mixture, that includes at least one catalyst, and from 0.1 wt % to 6.0 wt % of a preformed aqueous polymer dispersion, based on the total weight of the mixture, the preformed aqueous polymer dispersion having a solids content from 10 wt % to 80 wt %, based on the total weight of the preformed aqueous polymer dispersion, and being one of an aqueous acid polymer dispersion or an aqueous acid-modified polyolefin polymer dispersion in which the polyolefin is derived from at least one C2 to C20 alpha-olefin.

The additive component may include a catalyst, a curing agent, a surfactant, a blowing agent, a polyamine, water, and/or a filler. The additive component accounts for 0.1 wt % to 50.0 wt % (e.g., 0.1 wt % to 40.0 wt %, 0.1 wt % to 30.0 wt %, 0.1 wt % to 20.0 wt %, 0.1 wt % to 15.0 wt %, 0.1 wt % to 10.0 wt %, 0.1 wt % to 5.0 wt %, etc.) of the additive component, based on the total weight of the isocyanate-reactive component. The additive component in exemplary embodiments includes at least one catalyst and at least one surfactant.

The preformed aqueous polymer dispersion accounts for 0.1 wt % to 6.0 wt % (e.g., 0.1 wt % to 5.0 wt %, 0.1 wt % to 4.1 wt %, 0.1 wt % to 4.0 wt %, 0.1 wt % to 3.5 wt %, 0.1 wt % to 3.0 wt %, 0.4 wt % to 2.5 wt %, 0.5 wt % to 2.4 wt %, etc.) of the isocyanate-reactive component.

The aqueous polymer dispersion includes at least (a) a base polymer including an acid polymer and/or an acid-modified polyolefin polymer and (b) a fluid medium (in this case water), in which the base polymer is dispersed in the fluid medium. The preformed aqueous polymer dispersion may be a continuous liquid phase component at ambient conditions of room temperature and atmospheric pressure and is derived from a liquid phase (i.e., the fluid medium) and a solid phase (i.e., the base polymer).

The preformed aqueous polymer dispersion is one of an aqueous acid polymer dispersion or an aqueous acid-modified polyolefin polymer dispersion in which the polyolefin is derived from at least one C₂ to C₂₀ alpha-olefin (e.g., at least one C₂ to C₁₀ alpha-olefin and/or C₂ to C₈ alpha-olefin). The preformed aqueous polymer dispersion has a solids content from 10 wt % to 80 wt %, based on the total weight of the preformed aqueous polymer dispersion. The aqueous polymer dispersion may be a combination of one or more aqueous polymer dispersions that are used to form the viscoelastic polyurethane foam.

Exemplary aqueous acid polymer dispersion may include ethylene-acrylic acid interpolymers, ethylene-methacrylic acid interpolymers, and/or ethylene-crotonic acid interpolymers. It is understood that in such an aqueous acid polymer dispersion, exemplary embodiments are not limited to just ethylene-acrylic acid interpolymers, ethylene-methacrylic acid interpolymers, and/or ethylene-crotonic acid interpolymers. For example, ethylene can be copolymerized with more than one of the following: acrylic acid, methacrylic acid, and/or crotonic acid.

EAA may be prepared by copolymerization of ethylene with acrylic acid, which yields ethylene-acrylic acid EAA copolymers. The ethylene-acrylic acid copolymer may have an acrylic acid content of at least 10 wt % (e.g., from 10 wt % to 70 wt %, from 10 wt % to 60 wt %, from 10 wt % to 50 wt %, from 10 wt % to 40 wt %, from 10 wt % to 30 wt %, and/or from 15 wt % to 25 wt %). Exemplary EAA copolymers are available as PRIMACOR™ products, available from THE DOW CHEMICAL COMPANY. The EAA copolymer may have a melt index from 100 to 2000 g/10 minute (ASTM Method D-1238 at 190° C. and 2.16 kg). The EAA copolymer may have a Brookfield viscosity from 5,000 to 13,000 cps at 350° F., and is available from The Dow Chemical Company. Exemplary, ethylene-acrylic acid, ethylene-methacrylic acid, and/or ethylene-crotonic acid copolymers are discussed in U.S. Pat. Nos. 4,599,392 and/or 4,988,781.

Exemplary aqueous acid-modified polyolefin polymer dispersions include dispersions sold as HYPOD™ products, available from The Dow Chemical Company. The aqueous acid-modified polymer dispersions may include propylene based dispersions and ethylene-based dispersions, which may combine the performance of high-molecular-weight thermoplastics and elastomers with the application advantages of a high-solids waterborne dispersion. The polyolefin of the dispersion may be a metallocene catalyzed polyolefin.

The aqueous polymer dispersion may be prepared by using a neutralizing agent. Exemplary neutralizing agents include ammonia, ammonium hydroxide, potassium hydroxide, sodium hydroxide, lithium hydroxide, and combinations thereof. For example, if a polar group of the base polymer is acidic or basic in nature, the polymer may be partially or fully neutralized with a neutralizing agent to form a corresponding salt. With the acid polymer modified dispersion prepared using EAA is used, the neutralizing agent is a base, such as ammonium hydroxide, potassium hydroxide, and/or sodium hydroxide. Those having ordinary skill in the art will appreciate that the selection of an appropriate neutralizing agent may depend on the specific composition formulated, and that such a choice is within the knowledge of those of ordinary skill in the art. The aqueous polymer dispersion may be prepared in an extrusion process, e.g., as discussed in U.S. Pat. No. 8,318,257.

The polyol component includes at least one polyether polyol and/or polyester polyol. Exemplary polyether polyols are the reaction product of alkylene oxides (such as at least one ethylene oxide, propylene oxide, and/or butylene oxide) with initiators containing from 2 to 8 active hydrogen atoms per molecule. Exemplary initiators include ethylene glycol, diethylene glycol, propylene glycol, dipropylene glycol, butane diol, glycerol, trimethylolpropane, triethanolamine, pentaerythritol, sorbitol, ethylene diamine, toluene diamine, diaminodiphenylmethane, polymethylene polyphenylene polyamines, ethanolamine, diethanolamine, and mixtures of such initiators. Exemplary polyols include VORANOL™ products, available from The Dow Chemical Company. The polyol component may include polyols that are useable to form viscoelastic polyurethane foams.

For example, the polyol component may include a polyoxyethylene-polyoxypropylene polyether polyol that has an ethylene oxide content of at least 50 wt %, that has a nominal hydroxyl functionality from 2 to 6 (e.g., 2 to 4), and has a number average molecular weight from 500 g/mol to 5000 g/mol (e.g., 500 g/mol to 4000 g/mol, from 600 g/mol to 3000 g/mol, 600 g/mol to 2000 g/mol, 700 g/mol to 1500 g/mol, and/or 800 g/mol to 1200 g/mol). The polyoxyethylene-polyoxypropylene polyether polyol that has an ethylene oxide content of at least 50 wt % may account for 5 wt % to 90 wt % (e.g., 10 wt % to 90 wt %, 35 wt % to 90 wt %, 40 wt % to 85 wt %, 50 wt % to 85 wt %, 50 wt % to 80 wt %, and/or 55 wt % to 70 wt %) of the isocyanate-reactive component. The polyoxyethylene-polyoxypropylene polyether polyol that has an ethylene oxide content of at least 50 wt % may be the majority component in the isocyanate-reactive component.

The polyol component may include a polyoxypropylene-polyoxyethylene polyether polyol that has an ethylene oxide content of less than 20 wt % that has a nominal hydroxyl functionality from 2 to 6 (e.g., 2 to 4) and has a number average molecular weight greater than 1000 g/mol (or greater than 1500 g/mol) and less than 6000 g/mol. For example, the molecular weight may be from 1500 g/mol to 5000 g/mol, 1600 g/mol to 5000 g/mol, 2000 g/mol to 4000 g/mol, and/or 2500 g/mol to 3500 g/mol. The polyoxypropylene-polyoxyethylene polyether polyol that has an ethylene oxide content of less than 20 wt % may account for 5 wt % to 90 wt % (e.g., 5 wt % to 70 wt %, 5 wt % to 50 wt %, 10 wt % to 40 wt %, and/or 10 wt % to 30 wt %) of the isocyanate reactive component. The polyoxypropylene-polyoxyethylene polyether polyol that has an ethylene oxide content of less than 20 wt % may be in a blend with the polyoxypropylene polyether polyol that has an ethylene oxide content of at least 50 wt %, whereas the latter of which is included in a greater amount.

The polyol component may include a polyoxypropylene polyether polyol that has a nominal hydroxyl functionality from 2 to 6 (e.g., 2 to 4) and has a number average molecular weight from 500 g/mol to 5000 g/mol (e.g., 500 g/mol to 4000 g/mol, from 600 g/mol to 3000 g/mol, 600 g/mol to 2000 g/mol, 700 g/mol to 1500 g/mol, and/or 800 g/mol to 1200 g/mol). The polyoxypropylene polyether polyol may account for 5 wt % to 90 wt % (e.g., 5 wt % to 70 wt %, 5 wt % to 50 wt %, 10 wt % to 40 wt %, and/or 10 wt % to 30 wt %) of the isocyanate reactive component. The polyoxypropylene polyether polyol may be in a blend with the polyoxypropylene polyether polyol that has an ethylene oxide content of at least 50 wt %, whereas the latter of which is included in a greater amount.

In an exemplary embodiment, the polyol component may include a blend of the polyoxyethylene-polyoxypropylene polyether polyol that has an ethylene oxide content of at least 50 wt %, the polyoxyethylene-polyoxypropylene polyether polyol that has an ethylene oxide content of less than 20 wt %, and the polyoxypropylene polyether polyol.

The polyol component may be mixed with the preformed aqueous polymer dispersion (and optionally at least part of the additive component) before contacting the isocyanate component.

### Additive Component

The additive component is separate from the components that form the preformed aqueous dispersion and the polyol component. The additive component is part of the isocyanate-reactive component, but other additives may be incorporated into the isocyanate component. The additive component may include a catalyst, a curing agent, a crosslinker, a surfactant, a blowing agent (aqueous and non-aqueous, separate from the aqueous polymer dispersion), a polyamine, a plasticizer, a fragrance, a pigment, an antioxidant, a UV stabilizer, water (separate from the aqueous polymer dispersion), and/or a filler. Other exemplary additives include a chain extender, flame retardant, smoke suppressant, drying agent, talc, powder, mold release agent, rubber polymer (“gel”) particles, and other additives that are known in the art for use in viscoelastic foams and viscoelastic foam products.

The additive component may include tin catalyst, zinc catalyst, bismuth catalyst, and/or amine catalyst. The total amount of catalyst in the isocyanate-reactive component may be from 0.1 wt % to 3.0 wt %.

A surfactant may be included in the additive component, e.g., to help stabilize the foam as it expands and cures. Examples of surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters, and alkyl arylsulfonic acids may be used. For example, the formulation may include a surfactant such as an organosilicone surfactant. The total amount of an organosilicone surfactant in the isocyanate-reactive component may be from 0.1 wt % to 5.0 wt %, 0.1 wt % to 3.0 wt %, 0.1 wt % to 2.0 wt %, and/or 0.1 wt % to 1.0 wt %.

The additive component may include water, which is separate from the preformed aqueous polymer dispersion. The water may account for less than 2.0 wt % of the total weight of isocyanate-reactive component. The total water, including water from the preformed aqueous polymer dispersion and water from the additive component, may account for less than 5 wt % of the total weight of isocyanate-reactive component.

The additive component may exclude any conventional polyurethane foam chemical cell openers based on the use of the aqueous polymer dispersion. The additive component may exclude polybutene, polybutadiene, and waxy aliphatic hydrocarbons such as oils (e.g., mineral oil, paraffin oil, and/or naphthenic oil) that are commonly employed cell openers in low resiliency foams. The additive component may exclude cell openers that are polyols derived primarily from alkoxylation of α,β-alkylene oxides having at least 4 carbon atoms, e.g., as discussed U.S. Pat. No. 4,596,665. The additive component may exclude cell openers that are polyethers of up to about 3500 molecular weight that contain a high proportion (usually 50 percent or higher) of units derived from ethylene oxide or butylene oxide, e.g., as discussed in the background section of U.S. Pat. No. 4,863,976. The additive component may exclude cell openers that are polyether polyols having a molecular weight of at least 5000 and having at least 50 wt % of oxyethylene units, e.g., as discussed in the claims of U.S. Pat. No. 4,863,976.

### Isocyanate Component

The isocyanate component includes at least one isocyanate. The isocyanate component is present at an isocyanate index from 50 to 110 (e.g., from 60 to 100, from 65 to 100, from 70 to 100, from 74 to 100, from 70 to 90, from 70 to 85, and/or from 74 to 85). The isocyanate index is defined as the molar stoichiometric excess of isocyanate moieties in a reaction mixture with respect to the number of moles of isocyanate-reactive units (active hydrogens available for reaction with the isocyanate moiety), multiplied by 100. An isocyanate index of 100 means that there is no stoichiometric excess, such that there is 1.0 mole of isocyanate groups per 1.0 mole of isocyanate-reactive groups, multiplied by 100.

The isocyanate component may include one or more isocyanate such as polyisocyanate and/or isocyanate-terminated prepolymer. The isocyanate may be isocyanate-containing reactants that are aliphatic, cycloaliphatic, alicyclic, arylaliphatic, and/or aromatic polyisocyanates or derivatives thereof. Exemplary derivatives include allophanate, biuret, and NCO (isocyanate moiety) terminated prepolymer. For example, the isocyanate component may include at least one aromatic isocyanate, e.g., at least one aromatic polyisocyanate or at least one isocyanate-terminated prepolymer derived from an aromatic polyisocyanate. The isocyanate component may include at least one isomer of toluene diisocyanate (TDI), crude TDI, at least one isomer of diphenyl methylene diisocyanate (MDI), crude MDI, and/or higher functional methylene polyphenyl polyisocyanate.

Examples include TDI in the form of its 2,4 and 2,6-isomers and mixtures thereof and MDI in the form of its 2,4′-, 2,2′- and 4,4′-isomers and mixtures thereof. The mixtures of MDI and oligomers thereof may be crude or polymeric MDI and/or a known variant of MDI comprising urethane, allophanate, urea, biuret, carbodiimide, uretonimine and/or isocyanurate groups. Exemplary isocyanates include VORANATE™ M 220 (a polymeric methylene diphenyl diisocyanate available from The Dow Chemical Company). Other exemplary polyisocyanate include tolylene diisocyanate (TDI), isophorone diisocyanate (IPDI) and xylene diisocyanates (XDI), and modifications thereof.

The viscoelastic polyurethane foam may be prepared in a slabstock process (e.g., as free rise foam), a molding process (such as in a box foaming process), or any other process known in the art. In a slabstock process, the components may be mixed and poured into a trough or other region where the formulation reacts, expands freely in at least one direction, and cures. Slabstock processes are generally operated continuously at commercial scales. In a molding process, the components may be mixed and poured into a mold/box (heated or non-heated) where the formulation reacts, expands without the mold in at least one direction, and cures.

The viscoelastic polyurethane foam may be prepared at initial ambient conditions (i.e., room temperature ranging from 20° C. to 25° C. and standard atmospheric pressure of approximately 1 atm). For example, the viscoelastic polyurethane foam may include an acid polymer and/or an acid-modified polyolefin polymer (e.g., a polymer that has a melting point above 100° C.) without requiring heating or application of pressure to the isocyanate-reactive component. Foaming at pressure below atmospheric condition can also be done, to reduce foam density and soften the foam. Foaming at pressure above atmospheric condition can be done, to increase foam density and therefore the foam load bearing as measured by indentation force deflection (IFD). In a molding processing, the viscoelastic polyurethane foam may be prepared at initial mold temperature above ambient condition, e.g., 50° C. and above. Overpacking of mold, i.e. filling the mold with extra foaming material, can be done to increase foam density.

The calculated total water content for the reaction system used to form the viscoelastic foam may be less than 5 wt %, less than 3 wt %, less than 2.0 wt %, and/or less than 1.6 wt %, based on the total weight of the reaction system for forming the viscoelastic polyurethane foam.

The calculated total water content is calculated as the total amount of DI (deionized water) added to the formulation plus the amount of water added to the formulation as part of the preformed aqueous polymer dispersion. For example, the calculated total water content may be from 0.5 wt % to 1.6 wt %, 0.5 wt % to 1.5 wt %, and/or 1.0 wt % to 1.5 wt %.

The resultant viscoelastic polyurethane foam may exhibit improved wicking effect and/or improved moisture/heat management. With respect to moisture and heat management of a resultant foam, e.g., with respect to a viscoelastic polyurethane foam mattress or pillow, a good wicking effect may enable sweat to move quickly away from a user's skin. The key aspects of human body to maintain the comfort temperature are through moisture vapor by sweating. Sweating is the body's mechanism of keeping us cool. Good wicking effect may enable the user to remain dry and cool so as providing increased comfort. The good wicking effect may also provide the sweat/water with more surface area to evaporate from. Said in another way, as the sweat/water is dispersed over a greater area it may evaporate more rapidly than when the water is pooled together over a small surface area. Further, good moisture permeability may enable moisture to leave a user's skin and enable natural moisture vapor to bring heat away from the user's skin. For example, the viscoelastic polyurethane foam may exhibit a visually observable wicking height (e.g., on a sample of the viscoelastic polyurethane foam having the dimensions of 1.0 inch×0.5 inch×2.0 inch, when an edge of the sample is submersed in 5.0 mm of dyed water) that is greater than a visually observable wicking height of a sample of a different viscoelastic polyurethane foam (which sample has the same dimensions) that is prepared using the same isocyanate-component, the same calculated total water content, and the same isocyanate-reactive component, except that the preformed aqueous polymer dispersion is excluded. For example, the wicking height may be greater by a factor of at least 3 (e.g., may be 3 to 10 times greater and/or 3.5 to 5.5 times greater).

The viscoelastic polyurethane foam may exhibit a visually observed wicking time (using a sample of the viscoelastic polyurethane foam), when three drops of dyed water are placed on a surface of the sample, that is less than a visually observed wicking time using a sample of a different viscoelastic polyurethane foam that is prepared using the same isocyanate-component, the same calculated total water content, and the same isocyanate-reactive component, except that the preformed aqueous polymer dispersion is excluded. As would be understanding, the compared samples may have a same thickness/depth, but the length and width of the samples are not dependent on the results. The wicking time is visually observed as the time at which it takes for three drops of dyed water to disappear (i.e., be absorbed by the foam) away from the surface of the samples. The wicking time may be decreased by at least 30 seconds so as to be significantly quicker when the preformed aqueous polymer dispersion is used. For example, the wicking time may be less than 5 seconds for the polyurethane foam prepared using the preformed aqueous polymer dispersion (e.g., greater than half a second).

The viscoelastic polyurethane foam may exhibit improved water vapor permeability, e.g., as measured according to ASTM E96/E96M (and optionally in view of ASTM E2321-03). For example, the water vapor permeability may be improved by at least 5% (e.g., from 5% to 20%) for the polyurethane foam prepared using the preformed aqueous polymer dispersion.

### Test Methods

### Melt Index/Melt Flow Rate

Melt index (I2), for ethylene-based polymers, is measured in accordance with ASTM D 1238-10, Condition, 190° C./2.16 kg, and is reported in grams eluted per 10 minutes. Melt index (I10), for ethylene-based polymers, is measured in accordance with ASTM D 1238-10, Condition 190° C./10 kg, and is reported in grams eluted per 10 minutes. Melt Flow Rate, MFR2, for propylene-based polymers is measured in accordance with ASTM D 1238-10, Condition 230° C./2.16 kg, and is reported in grams eluted per 10 minutes. Melt Flow Rate, MFR10, for propylene-based polymers is measured in accordance with ASTM D 1238-10, Condition 230° C./10 kg, and is reported in grams eluted per 10 minutes.

### Density

Density is measured in accordance with ASTM D792.

### High Temperature Gel Permeation Chromatography (HT-GPC)

### Propylene Interpolymers

The polymers are analyzed by gel permeation chromatography (GPC) on a Polymer Laboratories PL-GPC-220 high temperature chromatographic unit equipped with three linear mixed bed columns, 300×7.5 mm (Polymer Laboratories PLgel Mixed B (10-micron particle size)). The oven temperature is at 160° C. with the autosampler hot zone at 160° C. and the warm zone at 145° C. The solvent is 1,2,4-trichlorobenzene containing 200 ppm 2,6-di-t-butyl-4-methylphenol (BHT). The flow rate is 1.0 milliliter/minute and the injection size is 100 microliters. A 0.15% by weight solution of the sample is prepared for injection by dissolving the sample in nitrogen purged 1,2,4-trichlorobenzene containing 200 ppm 2,6-di-t-butyl-4-methylphenol for 2.5 hrs at 160° C. with gentle mixing.

The molecular weight determination is deduced by using ten narrow molecular weight distribution polystyrene standards (from Polymer Laboratories, EasiCal PS1 ranging from 580-7,500,000 g/mole) in conjunction with their elution volumes. BHT was used as a relative flowrate marker referencing each chromatographic run back to the polystyrene narrow standards calibration curve.

The equivalent polypropylene molecular weights are determined by using appropriate Mark-Houwink coefficients for polypropylene (as described by Th. G. Scholte, N. L. J. Meijerink, H. M. Schoffeleers, and A. M. G. Brands, J. Appl. Polym. Sci., 29, 3763-3782 (1984), incorporated herein by reference) and polystyrene (as described by E. P. Otocka, R. J. Roe, N. Y. Hellman, P. M. Muglia, Macromolecules, 4, 507 (1971) incorporated herein by reference) in the Mark-Houwink equation (EQ 1), which relates intrinsic viscosity to molecular weight. The instantaneous molecular weight (M_{(PP)}) at each chromatographic point is determined by EQ 2, using universal calibration and the Mark-Houwink coefficients as defined in EQ 1. The number-average, weight-average, and z-average molecular weight moments, Mn, Mw, and Mz were calculated according to EQ 3, EQ 4, and EQ 5, respectively, wherein RI is the baseline-subtracted refractometer signal height of the polymer elution peak at each chromatographic point (i).

{η}=KM^{a} (EQ 1)

where Kₚₚ=1.90E-04, aₚₚ=0.725 and Kₚₛ=1.26E-04, aₚₛ=0.702.

$$\begin{matrix}{M}_{( PP )} = {( \frac{{K}_{PS} {M}_{PS}^{{a}_{PS} + 1}}{{K}_{PP}} )}^{\frac{1}{{a}_{PP} + 1}} & ( EQ 2 ) \\ {Mn}_{( GPC )} = \frac{{\sum }^{i} {RI}_{i}}{{\sum }^{i} ( {RI}_{i} / {M}_{{( PP )}_{i}} )} & ( EQ 3 ) \\ {Mw}_{( GPC )} = \frac{{\sum }^{i} ( {RI}_{i} * {M}_{{( PP )}_{i}} )}{{\sum }^{i} {RI}_{i}} & ( EQ 4 ) \\ {Mz}_{( GPC )} = \frac{{\sum }^{i} ( {RI}_{i} * {{{M}_{( PP )}}_{i}}^{2} )}{{\sum }^{i} ( {RI}_{i} * {M}_{{( PP )}_{i}} )} & ( EQ 5 )\end{matrix}$$

### Ethylene-Based Polymers

A PolymerChar (Valencia, Spain) high temperature Gel Permeation Chromatography system consisting of an infra-red concentration detector (IR-5) was used for MW and MWD determination. The solvent delivery pump, the on-line solvent degas device, auto-sampler, and column oven were from Agilent. The column compartment and detector compartment were operated at 150° C. The columns were three PLgel 10 μm Mixed-B, columns (Agilent). The carrier solvent was 1,2,4-trichlorobenzene (TCB) with a flow rate of 1.0 mL/min. Both solvent sources for chromatographic and sample preparation contained 250 ppm of butylated hydroxytoluene (BHT) and were nitrogen sparged. Polyethylene samples were prepared at targeted polymer concentrations of 2 mg/mL by dissolving in TCB at 160° C. for 3 hour on the auto-sampler just prior the injection. The injection volume was 200 μL.

Calibration of the GPC column set was performed with 21 narrow molecular weight distribution polystyrene standards. The molecular weights of the standards ranged from 580 to 8,400,000 g/mol, and were arranged in 6 “cocktail” mixtures, with at least a decade of separation between individual molecular weights. The polystyrene standard peak molecular weights were converted to polyethylene molecular weights using the following equation (as described in Williams and Ward, J. Polym. Sci., Polym. Let., 6, 621 (1968)):

M_{polyethylene}=A(M_{polystyrene}) (1)

Here B has a value of 1.0, and the experimentally determined value of A is around 0.42.

A third order polynomial was used to fit the respective polyethylene-equivalent calibration points obtained from equation (1) to their observed elution volumes. The actual polynomial fit was obtained so as to relate the logarithm of polyethylene equivalent molecular weights to the observed elution volumes (and associated powers) for each polystyrene standard.

Number-, weight- and z-average molecular weights are calculated according to the following equations:

$$\begin{matrix}\overline{Mn} = \frac{{\sum }^{i} {Wf}_{i}}{{\sum }^{i} ( {Wf}_{i} / {M}_{i} )} & ( 2 ) \\ \overline{Mw} = \frac{{\sum }^{i} ( {Wf}_{i} * {M}_{i} )}{{\sum }^{i} {Wf}_{i}} & ( 3 ) \\ \overline{Mz} = \frac{{\sum }^{i} ( {Wf}_{i} * {M}_{i}^{2} )}{{\sum }^{i} ( {Wf}_{i} * {M}_{i} )} & ( 4 )\end{matrix}$$

Where, Wfᵢ is the weight fraction of the i-th component and Mᵢ is the molecular weight of to the i-th component. The MWD is expressed as the ratio of the weight average molecular weight (Mw) to the number average molecular weight (Mn).

The accurate A value was determined by adjusting A value in equation (1) until Mw, the weight average molecular weight calculated using equation (3) and the corresponding retention volume polynomial, agreed with the independently determined value of Mw obtained in accordance with the linear homopolymer reference with known weight average molecular weight of 120,000 g/mol.

### Differential Scanning Calorimetry (DSC)

Differential Scanning calorimetry (DSC) is used to measure the melting and crystallization behavior of a polymer over a wide range of temperatures. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties. The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tm), peak crystallization temperature (Tc), onset crystallization temperature (Tc onset), heat of fusion (Hf) (in Joules per gram), the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (Hf) and the peak melting temperature are reported from the second heat curve. Peak crystallization temperature and onset crystallization temperature are determined from the cooling curve.

### 13C-NMR

### Sample Preparation

The samples were prepared by adding approximately 2.7 g of a 50/50 mixture of tetrachloroethane-d2/orthodichlorobenzene containing 0.025 M Cr(AcAc)3 to 0.25 g sample in a Norell 1001-7 10 mm NMR tube. The samples were dissolved and homogenized by heating the tube and its contents to 150° C. using a heating block and vortex mixer. Each sample was visually inspected to ensure homogeneity.

### Data Acquisition Parameters

The data were collected using a Bruker 400 MHz spectrometer equipped with a Bruker Dual DUL high-temperature CryoProbe. The data were acquired using 320 transients per data file, a 6 sec pulse repetition delay, 90 degree flip angles, and inverse gated decoupling with a sample temperature of 120° C. All measurements were made on non-spinning samples in locked mode. Samples were allowed to thermally equilibrate for 7 minutes prior to data acquisition. The ¹³C NMR chemical shifts were internally referenced to the mmmm pentad at 21.90 ppm or the EEE triad at 30.0 ppm.

### Data Analysis

Composition was determined using the assignments from S. Di Martino and M. Kecichtermans, “Determination of the Composition of Ethylene-Propylene-Rubbers Using 13C-NMR Spectroscopy,” Journal of Applied Polymer Science, Vol. 56, 1781-1787 (1995), and integrated C13 NMR spectra to solve the vector equation s=fM where M is an assignment matrix, s is a row vector representation of the spectrum, and f is a mole fraction composition vector. The elements of f were taken to be triads of E and O with all permutations of E and O. The assignment matrix M was created with one row for each triad in f and a column for each of the integrated NMR signals. The elements of the matrix were integral values determined by reference to the assignments in Ref. 1. The equation was solved by variation of the elements of f as needed to minimize the error function between s and the integrated C13 data for each sample. This is easily executed in Microsoft Excel using the Solver function.

### Apparent Density

A sample material is cut into a square piece of 15 cm×15 cm in size. The volume of this piece is calculated from the thickness measured at four points. The division of the weight by the volume gives the apparent density (an average of four measurements is taken).

### Calculated Total Water Content

Calculated Total Water Content (parts by weight) is calculated as the total amount of DI (deionized water) added to the formulation plus the amount of water added to the formulation as part of the aqueous dispersion.

### Air Flow of Individual Layers

Air flow is a measure of the air that is able to pass through a sample under a given applied air pressure. Air flow is measured as the volume of air which passes through a 1.0 inch (2.54 cm) thick×2 inch×2 inch (5.08 cm) square section of sample at 125 Pa (0.018 psi) of pressure. Units are expressed in standard cubic feet per minute (scfm). A representative commercial unit for measuring air flow is manufactured by TexTest AG of Zurich, Switzerland and identified as TexTest Fx3300. Herein, air flow is measured according to ASTM D 3574.

### Polyurethane Resiliency

Average resiliency is measured according to ASTM D 3574, in particular using the ball rebound test. Recovery time is measured is measured by releasing/returning the compression load head from a 75% position (i.e., the foam sample is compressed to 100% minus 75% of the sample's original thickness) to the position where foam compression is to a 10% position (based on the original thickness of the foam sample). The Recovery Time is defined as the time from the releasing/returning the compression load head to the moment that the foam pushes back against the load head with a force of at least 1 newton.

### Indentation Force Deflection

IFD is referred to as indentation force deflection and it is measured according to ASTM D 3574. IFD is defined as the amount of force in pounds required to indent a fifty square inch sample a certain percentage of the sample's original thickness. Herein, IFD is specified as the number of pounds at 25% deflection and at 65% deflection for the foam sample. Lower IFD values are sought for viscoelastic foams. For example, an IFD at 25% from 6 to 12 may be used for bed pillows, thick back pillows, etc. An IFD at 25% from 12 to 18 may be used for medium thickness back pillows, upholstery padding, etc. An IFD at 25% from 18 to 24 may be used for thin back pillows, tufting matrix, very thick seat cushions, etc. An IFD at 25% greater than 24 may be used for average to firmer seat cushions, firm mattresses, shock absorbing foams, packaging foams, carpet pads, and other uses requiring ultra-firm foams.

IFD at 25% Return is the ability of the foam to recover. In particular, the IFD at 25% Return is measured as the percentage of the IFD at 25% that is recovered after cycling through the IFD at 65% measurement and returning to 25% compression.

### Tear Strength

As used herein, the term “tear strength” is used herein to refer to the maximum average force required to tear a foam sample which is pre-notched with a slit cut lengthwise into the foam sample. The test results are determined according to the procedures of ASTM D3574-F in pound-force per linear inch (lb_{f}/in) or in newtons per meter (N/m).

### Air Flow Under Compressive Strain

The equipment used for “ASTM D3574 Test G” (air permeability of foam) was adapted for this procedure. The air permeability tester has a cavity into which a copper mesh insert of a 100-mesh sieve size (as used in ASTM E11) was cut into the appropriate dimensions to fit exactly into the cavity, and placed snugly into the bottom of the cavity, the bottom material (can be 3d-loop structure or PU conventional foam) is placed into the cavity on the copper mesh insert, and then the top material is placed exactly on top of the bottom material. The bottom material and the top material was each sized to be a 1.0 inch (2.54 cm) thick×2 inch×2 inch (5.08 cm) square sample. For the top material, one (corresponding to a total composite compression of 50%) or two (corresponding to a total composite compression of 67%) pieces of the 1.0-inch thick×2-inch×2-inch dimension specimens can be used. Compression is then applied from the top using a copper mesh square sheet (100-mesh as used in ASTM E11) of approximately 1 foot (30 cm)×1 foot (30 cm) in dimensions, until the copper mesh square sheet is completely touching the table of the equipment, such that the total composite thickness after compression becomes 1.0 inch. Air flow is measured as the volume of air which passes through the composite structure at 125 Pa (0.018 psi) of pressure.

### EXAMPLES

### Three Dimensional Random Loop Layer

### Inventive Resins

Inventive resin 1 is a propylene interpolymer comprising at least 60 wt. % units derived from propylene and between 1 and 40 wt. % units derived from ethylene, having a density of 0.876 g/cc and a melt flow rate, MFR, of 25.0 g/10 min (230° C./2.16 kg), which is available as VERSIFY™ 4200 from The Dow Chemical Company (Midland, Mich.).

Inventive resin 2 is an ethylene/alpha-olefin block copolymer having a density of 0.877 g/cc and a melt index, 12, of 15 g/10 min (190° C./2.16 kg), which is available as INFUSE™ 9817 from The Dow Chemical Company (Midland, Mich.).

Inventive resin 3 is an ethylene/alpha-olefin interpolymer composition as further outlined below.

Inventive resin 4 is an ethylene/alpha-olefin copolymer having a density of 0.910 g/cc and a melt index, 12, of 15 g/10 min (190° C./2.16 kg), which is available as ELITE™ 5815 from The Dow Chemical Company (Midland, Mich.)).

Inventive resin 5 is an ethylene/alpha-olefin copolymer having a density of 0.900 g/cc and a melt index, 12, of 6 g/10 min (190° C./2.16 kg), which is available as AFFINITY™ 1280G from The Dow Chemical Company (Midland, Mich.)).

### Inventive Resin 3

Inventive resin 3 is prepared via solution polymerization in a dual loop reactor system in the presence of a Zirconium-based catalyst system comprising [2,2′″-[1,3-propanediylbis(oxy-κO)]bis[3″,5,5″-tris(1,1-dimethylethyl)-5′-methyl[1,1′:3′,1″-terphenyl]-2′-olato-κO]]dimethyl-, (OC-6-33)-Zirconium, represented by the following formula:

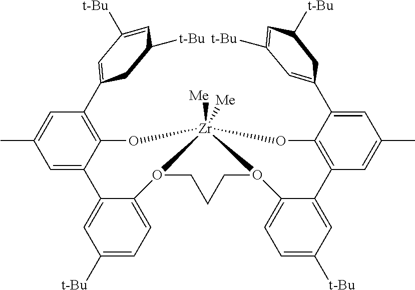

The polymerization conditions for the inventive resin 3 is reported in Tables 1 and 2. Referring to Tables 1 and 2, MMAO is modified methyl aluminoxane; and RIBS-2 is bis(hydrogenated tallow alkyl)methyl, tetrakis(pentafluorophenyl)borate(1-) amine

TABLE 1

| 1. REACTOR FEEDS | Unit | Inventive Resin 3 |
|---|---|---|
| Primary Reactor Feed | ° C. | 29.89 |
| Temperature | | |
| Primary Reactor Fresh | lbs/hr | 210.28 |
| Ethylene Flow | | |
| Primary Reactor Total | lbs/hr | 217.95 |
| Ethylene Flow | | |
| Comonomer Type Used | | 1-octene |
| Primary Reactor Fresh | lbs/hr | 77.39 |
| Comonomer Flow | | |
| Primary Reactor Total | lbs/hr | 133.84 |
| Comonomer Flow | | |
| Primary Reactor | % | 38.03 |
| Comonomer/Olefin Ratio | | |
| Primary Reactor Feed | Ratio | 4.78 |
| Solvent/Ethylene Ratio | | |
| Primary Reactor Fresh | Standard | 10859.95 |
| Hydrogen Flow | cm³/min | |
| Primary Reactor Hydrogen | mol % | 0.82 |
| Mole Percent | | |
| Secondary Reactor Feed | ° C. | 25.52 |
| Temperature | | |
| Secondary Reactor Fresh | lbs/hr | 170.89 |
| Ethylene Flow | | |
| Secondary Reactor Total | lbs/hr | 174.77 |
| Ethylene Flow | | |
| Secondary Reactor Fresh | lbs/hr | 0.00 |
| Comonomer Flow | | |
| Secondary Reactor Total | lbs/hr | 28.76 |
| Comonomer Flow | | |
| Secondary Reactor | % | 14.10 |
| Comonomer/Olefin Ratio | | |
| Secondary Reactor Feed | Ratio | 2.67 |
| Solvent/Ethylene Ratio | | |
| Secondary Reactor Fresh | Standard | 4073.17 |
| Hydrogen Flow | cm³/minute | |
| Secondary Reactor Hydrogen | mol % | 0.32 |
| Mole Percent | | |

TABLE 2

| | Unit | Inventive Resin 3 |
|---|---|---|
| 2. REACTION | | |
| Primary Reactor Control | ° C. | 150.04 |
| Temperature | | |
| Primary Reactor Ethylene | % | 84.79 |
| Conversion | | |
| Primary Reactor Percent Solids | % | 15.10 |
| Primary Reactor Polymer | min | 9.74 |
| Residence Time | | |
| Secondary Reactor Control | ° C. | 189.96 |
| Temperature | | |
| Secondary Reactor Ethylene | % | 86.54 |
| Conversion | | |
| Secondary Reactor Percent | % | 24.44 |
| Solids | | |
| Secondary Reactor Polymer | min | 6.51 |
| Residence Time | | |
| Vent Ethylene Conversion | % | 94.02 |
| Primary Reactor Split | % | 40.70 |
| 3. CATALYST | | |
| Primary Reactor Catalyst Type | — | Zirconium-Based |
| | | Catalyst |
| Primary Reactor Catalyst Flow | lbs/hr | 1.05 |
| Primary Reactor Catalyst | ppm | 100.00 |
| Concentration | | |
| Primary Reactor Catalyst | 10⁶ Lb | 1.75 |
| Efficiency | | |
| Primary Reactor Catalyst-1 | mw | 90.86 |
| Mole Weight | | |
| Primary Reactor Co-Catalyst-1 | Ratio | 1.13 |
| Molar Ratio | | |
| Primary Reactor Co-Catalyst-1 | — | RIBS-2 |
| Type | | |
| Primary Reactor Co-Catalyst-1 | lbs/hr | 0.53 |
| Flow | | |
| Primary Reactor Co-Catalyst-1 | ppm | 2999.36 |
| Concentration | | |
| Primary Reactor Co-Catalyst-2 | Ratio | 9.98 |
| Molar Ratio | | |
| Primary Reactor Co-Catalyst-2 | — | MMAO |
| Type | | |
| Primary Reactor Co-Catalyst-2 | lbs/hr | 0.63 |
| Flow | | |
| Primary Reactor Co-Catalyst-2 | ppm | 498.18 |
| Concentration | | |
| Secondary Reactor Catalyst | — | Zirconium-Based |
| Type | | Catalyst |
| Secondary Reactor Catalyst | lbs/hr | 1.58 |
| Flow | | |
| Secondary Reactor Catalyst | ppm | 100.00 |
| Concentration | | |
| Secondary Reactor Catalyst | 10⁶ Lb | 1.69 |
| Efficiency | | |
| Secondary Reactor Co-Catalyst-1 | Ratio | 1.20 |
| Molar Ratio | | |
| Secondary Reactor Co-Catalyst-1 | — | RIBS-2 |
| Type | | |
| Secondary Reactor Co-Catalyst-1 | lbs/hr | 0.83 |
| Flow | | |
| Secondary Reactor Co-Catalyst-1 | ppm | 2999.36 |
| Concentration | | |
| Secondary Reactor Co-Catalyst-2 | Ratio | 4.74 |
| Molar Ratio | | |
| Secondary Reactor Co-Catalyst-2 | — | MMAO |
| Type | | |
| Secondary Reactor Co-Catalyst-2 | lbs/hr | 0.90 |
| Flow | | |
| Secondary Reactor Co-Catalyst-2 | ppm | 248.12 |
| Concentration | | |
| 4. POLYMER | | |
| GI200 Average Gel Area | mm²/24.6 | 1.57 |
| | cm³ | |
| GI200 Std Dev Gel Area | mm²/24.6 | 4.46 |
| | cm³ | |

TABLE 3
Properties of Inventive Resins

| | Inventive | Inventive | Inventive | Inventive | Inventive |
|---|---|---|---|---|---|
| | Resin 1 | Resin 2 | Resin 3 | Resin 4 | Resin 5 |
| Density | 0.876 | 0.877 | 0.906 | 0.910 | 0.900 |
| (g/cm³) | | | | | |
| MFR or I₂ | 25.0 | 15.0 | 14.3 | 15.0 | 6.0 |
| (g/10 minutes) | | | | | |
| MFR₁₀/MFR₂ | 9.0 | 7.3 | 6.9 | 6.8 | 43.1 |
| or I₁₀/I₂ | | | | | |
| Mₙ (g/mol) | 75,170 | 11,760 | 20,558 | 18,488 | 22,740 |
| M_{w} (g/mol) | 172,400 | 63,850 | 50,574 | 54,345 | 61,450 |
| M_{z} (g/mol) | 327,700 | 112,500 | 95,081 | 133,502 | 112,800 |
| M_{w}/Mₙ | 2.29 | 5.43 | 2.46 | 2.94 | 2.70 |
| Highest Tₘ | 84.0 | 120.0 | 101.5 | 123.4 | 96.0 |
| peak (° C.) | | | | | |
| Tc (° C.) | 45.0 | 104.0 | 81.0 | 98.9 | 79.0 |
| ΔTm − Tc | 39.0 | 16.0 | 20.5 | 24.5 | 17.0 |
| % | 21.0 | 17.4 | 39.1 | 44.2 | 37.0 |
| Crystallinity | | | | | |

The inventive resins were used to make corresponding three dimensional random loop layers. The three dimensional random loop layers were made according to the procedure described in U.S. Pat. No. 7,625,629, which is incorporated by reference herein in its entirety. As shown in Table 4 below, the three dimensional random loop layers were tested for air flow. The control is air flow measured when no sample is present.

TABLE 4
Air Flow of 3D Random Loop Layers Only

| | Inven- | Inven- | Inven- | Inven- | Inven- |
|---|---|---|---|---|---|
| | tive | tive | tive | tive | tive |
| | Layer 1 | Layer 2 | Layer 3 | Layer 4 | Layer 5 |
| Apparent | 4.0 | 2.7 | 2.5 | 2.3 | 2.4 |
| Density (lb/ft³) | | | | | |
| ASTM Air | 29.8 | 43.2 | 39.1 | 38.4 | 45.0 |
| Flow (scfm or | | | | | |
| ft³/min) | | | | | |

### Viscoelastic Polyurethane Foam Layer

The materials principally used are the following:
AD 1 An aqueous acid polymer dispersion including approximately 21.7 wt % of a potassium hydroxide neutralized ethylene-acrylic acid copolymer salt and 78.3 wt % of water, made using a twin screw extruder and a dilution scheme as described in U.S. Pat. No. 8,318,257, is prepared as follows:
   A first feed includes 100 wt % of PRIMACOR™ 5986 (an ethylene acrylic acid resin having approximately 20.5 wt % of acrylic acid) at a flow rate of 234 lb/h, a second feed includes 45 wt % of potassium hydroxide at a flow rate of 125 lb/h, and a third feed includes 100 wt % of water at a flow rate of 50 lb/h. A first dilution pump feeds water at 220 lb/h and a second dilution pump at 538 lb/h to achieve the desired solids content. The barrel/zone temperature control conditions are the following:

TABLE 5

| Zone Number | Temperature ° C. |
|---|---|
| Zone 1 | 27 |
| Zone 2 | 151 |
| Zone 3 | 147 |
| Zone 4 | 148 |
| Zone 5 | 161 |
| Zone 6 | 149 |
| Zone 7 | 107 |
| Zone 8 | 109 |
| Zone 9 | 80 |
| Zone 10 | 131 |
| Zone 11 | 72 |
| Zone 12 | 72 |

Polyol 1 A polyoxypropylene polyether polyol, having a nominal hydroxyl functionality of 3 and a number average molecular weight of approximately 1000 g/mol (available as VORANOL™ 3150 from The Dow Chemical Company).
Polyol 2 A glycerine initiated polyoxyethylene-polyoxypropylene polyether polyol, having an ethylene oxide content of approximately 60 wt %, a nominal hydroxyl functionality of 3, primary hydroxyl content of approximately 35%, and a number average molecular weight of approximately 1000 g/mol.
Polyol 3 An polyoxypropylene-polyoxyethylene polyether polyol initiated with glycerine, having an ethylene oxide content of less than 20 wt %, a nominal hydroxyl functionality of 3, and a number average molecular weight of approximately 3100 g/mol (available as VORANOL™ 3136 from The Dow Chemical Company).
Polyol 4 A high ethylene oxide content polyether triol with a hydroxyl number of 33.5 mg κOH/g, available as VORANOL™ CP 1421 from The Dow Chemical Company
Polyol 5 A high reactivity capped polyether triol with high molecular weight, a hydroxyl number of 34.0 mg κOH/g, and high primary hydroxyl content, available as VORANOL™ 4701 from The Dow Chemical Company
Polyol 6 An polyoxypropylene-polyoxyethylene polyether polyol initiated with glycerine, having an ethylene oxide content of less than 20 wt %, a nominal hydroxyl functionality of 3, and a number average molecular weight of approximately 3100 g/mol (available as VORANOL™ 8136 from The Dow Chemical Company).
Polyol 7 A grafted polyether polyol containing copolymerized styrene and acrylonitrile (available as VORANOL™ 3943A from The Dow Chemical Company)
PMDI Isocyanate A polymeric methylene diphenyl diisocyanate PMDI (available as PAPI™ 94 from The Dow Chemical Company).
TDI Isocyanate A 80:20 mixture of the 2,4- and 2,6-isomers of toluene diisocyanate (TDI), available from The Dow Chemical Company as VORANATE™ T-80.
Surfactant 1 An organosilicone surfactant (available as Niax L-618 from Momentive Performance Materials).
Surfactant 2 Polysiloxane polyoxyalkylene block copolymer to be used as a foam stabilizer in the manufacturing process of flexible polyurethane slabstock and molded foams, available as TEGOSTAB BF 2370 from Evonik Industries AG.
Surfactant 3 An organosilicone surfactant (available as DABCO DC5986 from Air Products & Chemicals).
Amine 1 A tertiary amine catalyst (available DABCO BL-11 from Air Products & Chemicals).
Amine 2 A tertiary amine catalyst (available as DABCO 33-LV from Air Products & Chemicals).
Tin catalyst A stannous octoate catalyst (available as KOSMOS 29 from Evonik Industries AG).
DI Water Deionized Water

TABLE 6
Polyurethane Formulations and Properties

| | Inven- | Compar- | Compar- | Compar- |
|---|---|---|---|---|
| | tive PU | ative A | ative B | ative C |
| Components | Foam | PU Foam | PU Foam | PU Foam |
| Polyol 1 | 20 | 20 | | |
| Polyol 2 | 60 | 60 | | |
| Polyol 3 | 20 | 20 | | |
| Polyol 4 | | | 75 | |
| Polyol 5 | | | 25 | |
| Polyol 6 | | | | 25 |
| Polyol 7 | | | | 75 |
| Deionized water | 1.10 | 2.20 | 4.50 | 5.25 |
| AD 1 | 1.40 | | | |
| Surfactant 1 | 0.8 | 0.8 | | |
| Surfactant 2 | | | 1.7 | |
| Surfactant 3 | | | | 1.8 |
| Amine 1 | 0.15 | 0.15 | | |
| Amine 2 | 0.05 | 0.05 | 0.6 | 0.1 |
| Tin catalyst | 0.05 | 0.05 | | 0.17 |
| Methylene chloride | | | | 8 |
| PMDI Isocyanate | 53.4 | 53.4 | | |
| TDI Isocyanate | | | 49.2 | 59.1 |
| INDEX | 80 | 80 | 101 | 105 |
| Total | 156.9 | 156.6 | 156.0 | 175.5 |
| Total water added | 2.20 | 2.20 | 4.50 | 5.25 |
| Formulation Total Mass | 1900 | 1900 | 850 | 750 |
| in grams | | | | |
| IFD @ 25% | 8.2 | 14.0 | 11.0 | 52.1 |
| Deflection(lb_{f}) | | | | |
| IFD @ 65% | 17.6 | 28.3 | 22.4 | 110.5 |
| Deflection(lb_{f}) | | | | |
| IFD @ 25% Return(lb_{f}) | 7.1 | 12.5 | 8.0 | 22.0 |
| IFD Support Factor(%) | 2.14 | 2.02 | 2.04 | 2.1 |
| IFD Hysteresis(%) | 87 | 89 | 73 | 42 |
| Average Resiliency(%) | 5 | 4 | 35 | 27 |
| Tear Strength (lb_{f}/in) | 1.32 | 1.08 | 2.48 | 1.65 |
| Tensile Strength (psi) | 11.7 | 10.3 | 13.3 | 15.7 |
| % Elongation | 87 | 92 | 208 | 69 |
| Density (lbₘ/ft³) | 2.82 | 2.96 | 1.33 | 0.99 |
| 90% Compression Set | 1.8 | 0.5 | 16.6 | 67.6 |
| (CT) | | | | |
| Air Flow (scfm) | 8.52 | 3.98 | 7.24 | 5.80 |

### Composite Cushioning Structures

Inventive composite cushioning structures were formed by positioning a three dimensional random loop layer and a viscoelastic polyurethane foam layer in a stacked configuration. Comparative cushioning structures were formed by positioning either a polyurethane foam layer or a three dimensional random loop layer and a viscoelastic polyurethane foam layer in a stacked configuration. The top layer and bottom layer are noted below.

TABLE 7
Composite Cushioning Structure Air Flow
Under Compressive Strain Results

| | | Air Flow |
|---|---|---|
| | | (ft³/min) Under |
| | | 50% Composite |
| | Description | Compressive Strain |
| Composite 1 | Comparative A PU Foam (top); | 1.18 |
| | Inventive 1 layer (bottom) | |
| Composite 2 | Inventive PU Foam (top); | 3.80 |
| | Inventive 1 layer (bottom) | |
| Composite 3 | Comparative A PU Foam (top); | 2.58 |
| | Inventive 2 layer (bottom) | |
| Composite 4 | Inventive PU Foam (top); | 5.95 |
| | Inventive 2 layer (bottom) | |
| Composite 5 | Comparative A PU Foam (top); | 1.51 |
| | Inventive 3 layer (bottom) | |
| Composite 6 | Inventive PU Foam (top); | 4.17 |
| | Inventive 3 layer (bottom) | |
| Composite 7 | Comparative A PU Foam (top); | 1.49 |
| | Inventive 4 layer (bottom) | |
| Composite 8 | Inventive PU Foam (top); | 4.20 |
| | Inventive 4 layer (bottom) | |
| Composite 9 | Comparative A PU Foam (top); | 1.82 |
| | Inventive 5 layer (bottom) | |
| Composite 10 | Inventive PU Foam (top); | 4.97 |
| | Inventive 5 layer (bottom) | |

TABLE 8
Composite Cushioning Structure Using
Polyurethane Foam Air Flow Results

| | | Air Flow |
|---|---|---|
| | | (ft³/min) Under |
| | | 50% Composite |
| | Description | Compressive Strain |
| Composite 11 | Comparative A PU Foam (top); | 1.77 |
| | Comparative B PU Foam (bottom) | |
| Composite 12 | Inventive PU Foam (top); | 3.20 |
| | Comparative B PU Foam (bottom) | |
| Composite 13 | Comparative A PU Foam (top); | 1.41 |
| | Comparative C PU Foam (bottom) | |
| Composite 14 | Inventive PU Foam (top); | 2.80 |
| | Comparative C PU Foam (bottom) | |

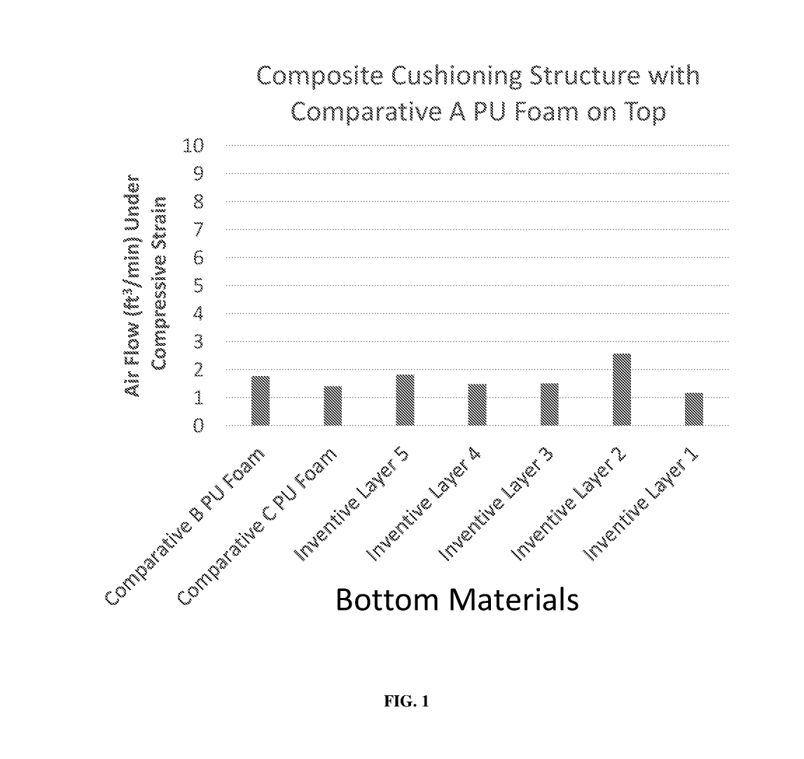

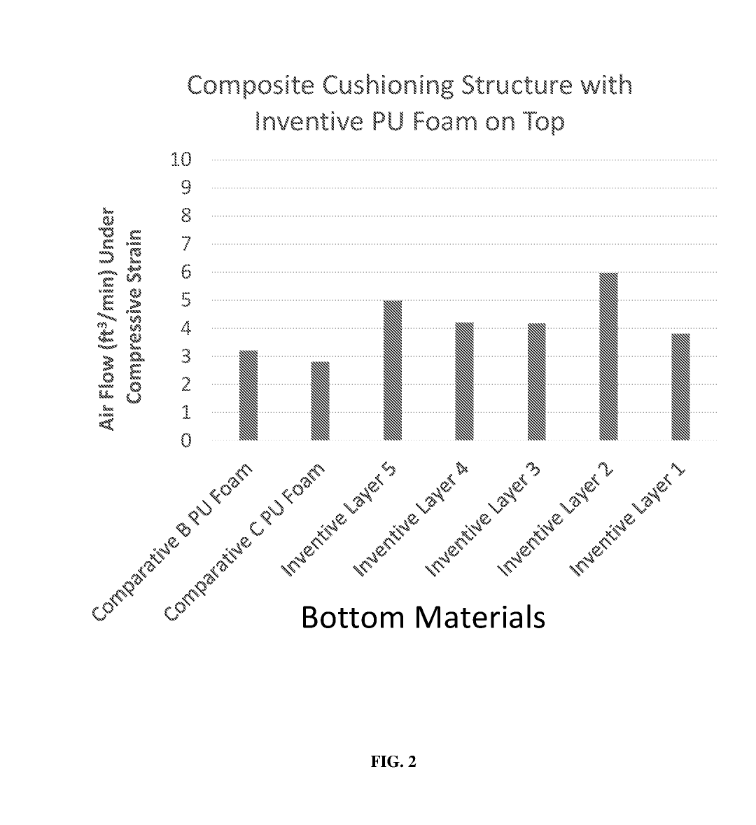

Referring to FIG. 1 depicted is the air flow under compressive strain for composite structures 1, 3, 5, 7, 9, which have 3D random loop bottom layers, and 11, and 13, which use polyurethane foam as the bottom layers. FIG. 2 depicts the air flow under compressive strain for composite structures 2, 4, 6, 8, 10, which have 3D random loop bottom layers, and 12, and 14, which use polyurethane foam as the bottom layers. High air flow values can be observed for composite structures 2, 4, 6, 8, and 10 in comparison to the other composite structures. Also, there is not much improvement, and in some cases, no improvement, in air flow values when comparative A PU foam is used, regardless of what is used as the bottom layer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composite cushioning structure comprising:
a three dimensional random loop layer comprising a plurality of random loops arranged in a three dimensional orientation formed from a polyolefin polymer; and
a viscoelastic polyurethane foam layer having an air flow of at least 6.0 ft³/min as measured according to ASTM D3574, Test G and a resiliency of less than or equal to 20%, as measured according to ASTM D3574 Test H.

2. The composite structure of claim 1, wherein the polyolefin polymer is an ethylene/alpha-olefin polymer having a density ranging from 0.870 g/cc to 0.935 g/cc and a melt index ranging from 1 to 25 g/10 min.

3. The composite structure of claim 2, wherein the ethylene/alpha-olefin polymer has a density ranging from 0.895 to 0.915 g/cc.

4. The composite structure of claim 2, wherein the ethylene/alpha-olefin polymer has a density ranging from 0.870 to 0.890 g/cc.

5. The composite structure of claim 2, wherein the ethylene/alpha-olefin polymer is characterized by a difference between a highest DSC temperature melting peak, Tm, and a highest DSC temperature crystallization peak, Tc, of greater than 19° C.

6. The composite structure of claim 1, wherein the polyolefin polymer is a propylene interpolymer comprising at least 60 wt. % units derived from propylene and between 1 and 40 wt. % units derived from ethylene, wherein the propylene interpolymer has a density of from 0.840 g/cm³ to 0.900 g/cm³, a highest DSC temperature melting peak of from 50.0° C. to 120.0° C., and a melt flow rate of from 1 to 100 g/10 min.

7. The composite structure of claim 6, wherein the propylene interpolymer is characterized by a difference between a highest DSC temperature melting peak, Tm, and a highest DSC temperature crystallization peak, Tc, of greater than 25° C.

8. The composite structure of claim 1, wherein each of the plurality of random loops has a diameter of about 0.1 mm to about 3 mm.

9. The composite structure of claim 1, wherein the layer of a plurality of random loops has an apparent density in a range of about 0.016 g/cm³ to about 0.1 g/cm³.

10. The composite structure of claim 1, wherein the viscoelastic polyurethane foam has a 90% compression set of less than or equal to 8%, as measured according to ASTM D3574 Test D (option CO.

11. The composite structure of claim 1, wherein the viscoelastic polyurethane foam is the reaction product of (a) an isocyanate component that includes at least one isocyanate having an isocyanate index of the reaction system being from 50 to 110; and (b) an isocyanate-reactive component that is a mixture comprising:
from 50.0 wt % to 99.8 wt % of a polyol component, based on the total weight of the mixture, the polyol component including at least one polyether polyol,
from 0.1 wt % to 50.0 wt % of an additive component, based on the total weight of the mixture, that includes at least one catalyst, and
from 0.1 wt % to 6.0 wt % of a preformed aqueous polymer dispersion, based on the total weight of the mixture, the preformed aqueous polymer dispersion having a solids content from 10 wt % to 80 wt %, based on the total weight of the preformed aqueous polymer dispersion, and being one of an aqueous acid polymer dispersion or an aqueous acid-modified polyolefin polymer dispersion in which the polyolefin is derived from at least one C₂ to C₂₀ alpha-olefin.

12. A method of manufacturing a composite cushioning structure, the method comprising:
providing a three dimensional random loop layer comprising a plurality of random loops arranged in a three dimensional orientation formed from a polyolefin polymer;
providing a viscoelastic polyurethane foam layer having an air flow of at least 6.0 ft³/min as measured according to ASTM D3574, Test G and a resiliency of less than or equal to 20%, as measured according to ASTM D3574 Test H; and
positioning the three dimensional random loop layer and the viscoelastic polyurethane foam layer such that the layers are in a stacked configuration.

13. The method of claim 12, wherein the viscoelastic polyurethane foam layer is positioned above the three dimensional random loop layer.

14. The method of claim 12, wherein the method further comprises providing an intermediate layer, and positioning the intermediate layer between the three dimensional random loop layer and the viscoelastic polyurethane foam layer.
